(19) United States
(12) Patent Application Publication
(10) Pub. No.: US 2017/0335054 A1
(43) Pub. Date: Nov. 23, 2017

(54) HEAT RESISTANT POLYETHYLENE TEREPHTHALATE AND PROCESS OF MANUFACTURING THEREOF

(71) Applicant: ESTER INDUSTRIES LIMITED, Uttarakhand (IN)

(72) Inventors: Sanjay Tammaji KULKARNI, Uttarakhand (IN); Balasundaram DILLYRAJ, Uttarakhand (IN); Chandrakant Omkar VYAS, Uttarakhand (IN)

(21) Appl. No.: 15/528,404

(22) PCT Filed: Nov. 20, 2015
(86) PCT No.: PCT/IN2015/050171

§ 371 Date: May 19, 2017

(30) Foreign Application Priority Data
Nov. 21, 2014 (IN) 3392/DEL/2014

(51) Int. Cl. C08G 63/183; C08G 63/80; C08G 63/85; C08G 63/83; G01N 30/02; C08K 5/00

(52) U.S. Cl. CPC C08G 63/183; C08G 63/80; C08K 5/0083; C08G 63/83; G01N 2030/025; C08G 63/85

(57) ABSTRACT

The present invention relates to a polyethylene terephthalate (PET) composition suitable for manufacturing heat resistant and/or microwaveable containers comprising at least one dicarboxylic acid; at least one diol; at least one nucleating agent; at least one or more crystallization suppressing agents; at least one or more additives; wherein the composition is characterized by at least one of the following properties: Intrinsic Viscosity>0.56 dL/g; Glass transition temperature (Tg)<60° C. and Crystallization exothermic peak temperature (Tch)<60° C.

### FIELD OF THE INVENTION

The present disclosure generally relates to a heat resistant polymer compositions and improved performance thereof. More particularly, it relates to a process for the preparation of polyethylene terephthalate (PET) polyester composition with improved thermal, optical, mechanical and rheological properties which can withstand high temperature without any deformation in its original shape.

### BACKGROUND OF THE INVENTION

For food packaging, gas/moisture barrier property is one of the key elements to provide longer shelf life of products. Aluminum foils, aluminum-metalized films, PVDC-coated films, or coextruded EVOH films have played major roles in barrier packaging. However, there are increasing demands for more sophisticated packaging, such as transparency, metal detector capability, microwaveability, and environmental friendliness as well as barrier properties. Polyester films are capable of meeting such demands and have become very popular recently.

PET polyester is a homopolymer made from one part dibasic acid or ester thereof i.e., TPA or DMT), and one part diol, e.g. MEG. Whereas copolymer is made from more than one dibasic acid or ester thereof and diol. Copolymers have some advantages over homopolymers as the copolymers remove processing limitations and provide increased physical properties at elevated temperature. In addition to DMT or TPA, isophthalic acid (IPA) can be used as a comonomer to reduce the rate and degree of crystallization to an extent that depends on its dosage. This broadens the processing parameters of food-container manufacturing machines. Glycols offer several opportunities for modification. During polycondensation, EG reacts with itself to some extent to form diethylene glycol (DEG). Higher amounts of DEG affect many polymer properties. There are other glycols available as partial substitutes for EG (e.g., neopentyl glycol, cyclohexane dimethanol). All these modifications lead to desired polymer property changes, i.e., reduction of the crystallization rate, melting point, etc. Cyclohexane dimethanol (CHDM) can react with a mixture of terephthalic and isophthalic acids in order to increase the melt strength of the polymer for extrusion processes.

On the other hand, some injection-molding and thermoforming applications can lead to improved heat resistance by accelerated crystallization rates in the article, which prevents physical deformation at elevated temperatures. This objective can be achieved by nucleation, which involves the addition of other ingredients to the polymer. Inert, insoluble substances (e.g., mica, talc), organic substances (e.g., aromatic alcohols), and certain polymers (e.g., PP, PE) can be used as nucleation ingredients to increase crystallization rates without compromising in transparency.

Such homopolymers are used to manufacture containers (i.e., bottles), by injection blow molding or injection-stretch blow molding. PET is also used for “ovenable” trays for frozen food and prepared meals. These trays are thermoformed from cast PET film and crystallized. Crystallization heat-sets the article to prevent deformation during cooking and serving. The main advantages of PET for this application include suitability for both conventional and microwave ovens.

U.S. Pat. No. 3,755,251 A relates to a process for the direct esterification of terephthalic acid with an alkylene glycol which comprises esterifying terephthalic acid with an alkylene glycol containing 2 to about 10 carbon atoms per molecule under direct esterification conditions wherein the glycol and acid are reacted in the presence of about 0.005 to about 0.100 weight percent based on the glycol, of a halogenated phenol employed as a catalyst therefor, selected from the group consisting of 4-iodophenol, 2,4,6-triiodophenol, 2,4,6-triiodo-m-cres01, tetrabromocatechol and 2,4,6-triidoresorcinol.

U.S. Pat. No. 7,199,210 B2 relates to a process for the preparation of polyethylene terephthalate by making use of non antimony catalysts. The Ti complex catalyst is pre-dispersed in the polymer matrix selected from PET, PBT, PCTG, PETG, PCT, PEN, PPT, PTT or any other related polyesters and prepared as a master batch. The key feature of the process is that the polyester obtained is having good whiteness, as against the yellowness normally encountered with Ti based catalysts, and also the polyester has very good clarity with minimum haze.

Similarly, EP 1413593 (CA 2451994) uses a product of tetra alkyl titanium compounds along with a phosphorous based compound and an aromatic carboxylic acid and claims a polyester having high ‘L’ and low ‘b’ values with reduced acetaldehyde.

CN 201410483490 discloses a heat-resisting polyethylene terephthalate resin composition and a preparation method thereof. The heat-resisting polyethylene terephthalate resin composition comprises the following raw materials in parts by mass: 66-72 parts of polyethylene terephthalate, 15-18 parts of carbon fibers, 5-10 parts of polyetherketone, 1-3 parts of di(3,5-tertiary butyl-4-hydroxyphenyl) sulfide and 4-6 parts of styrene-acrylonitrile-maleic anhydride copolymers. The resin obtained by reasonably compounding the polyethylene terephthalate, the carbon fibers, the polyetherketone, the di(3,5-tertiary butyl-4-hydroxyphenyl) sulfide and the styrene-acrylonitrile-maleic anhydride copolymers not only has relatively good comprehensive property, but also has good heat resistance, and is capable of resisting high temperature of 200 DEG C.

U.S. Pat. No. 3,696,071 A provides a process for the preparation of a linear high molecular weight, film and fiber forming polyester, which comprise reacting an aromatic dicarboxylic acid with a polyol containing 2 to about 10 carbon atoms per molecule under direct esterification conditions in the presence of an equimolar mixture of cuprous and cupric inorganic chloride salts in an amount sufficient to catalyze said reaction and to improve the thermal and aminolytic stabilization of said polyester, and then further polycondensing said polyester until the desired viscosity is obtained.

To become dual-ovenable, the PET must be crystallized during the thermoforming process. The PET, e.g. Crystallized (Polyethylene Terephthalate) (CPET), contains nucleating agents that assist in the molecular crystallization. A key factor to consider, while thermoforming CPET, is the intrinsic viscosity (I.V.) of the material. The amount of crystallization and the I.V. determines the balance between the container's stiffness at low and high temperatures. Generally the crystallinity of the finished container is 28-32% and the I.V. ranges from 0.85 to 0.95. The transparency, however, is affected due to high crystallinity and the finished articles has some haze effect leading to lower transparency.

During the polymer manufacturing, the polymer, due to fast crystallization nature of PET, gets some crystallization on cooling from polymer melt under water cutter which leads to some crystallinity in the polymer chips. Thus, the polymer gets crystallized granulating polymer chips from the molten polymer.

It is therefore desired to control the crystallinity of the polyester or of articles manufactured thereof up to 45%. It is also desired to control shape and size of the crystallites up to 0.5 micron in such a manner that finished article can have improved heat resistance so that it can withstand to microwave temperature without any deformation in its original shape.

### OBJECTS OF THE INVENTION

An object of the present invention, is to obtain heat resistant and microwaveable polyethylene terephthalate polyester with improved processability and molding properties and products made thereof.

Another object of the present invention, is to provide a process to manufacture modified polyester with improved heat resistance properties suitable for making articles which can withstand high temperature.

Another object of the present invention, is to control the growth and propagation of crystallites of the modified polyester so as to achieve good transparency and clarity.

Further object of the present invention, is to provide a process for preparing polyethylene terephthalate polyester with improved thermal, optical, mechanical and rheological properties.

Further object of the present invention, is to provide a process to promote both nucleation and propagation of crystallization of the polyethylene terephthalate polyester simultaneously.

Still further object of the present invention, is to provide transparent rigid packaging containers, films including other polymeric articles which are capable of withstanding microwave temperature without undergoing any deformation.

Still another object of the present invention, is to achieve the crystallized polyester with improved impact strength.

Further object of the present invention, is to prepare articles made of the modified polyester through Injection Blow Moulding (IBM), Injection Stretch Blow Moulding (ISBM), and Extrusion Blow Moulding (EBM) and the like methods.

Other objects and advantages of the present disclosure will be more apparent from the following description which is not intended to limit the scope of the present disclosure.

### SUMMARY OF THE INVENTION

The present invention provides a novel composition of the copolyester and improved process for manufacturing thereof. The process of the present invention becomes distinct over the prior art when it incorporates both steps nucleation for initiating the crystallization and suppression to control the size of the crystallites during the crystallization, in melt polymerization phase.

The crystallization of the polyester can be achieved by additional of nucleating agents e.g. PBT etc. which are responsible to increase the rate of crystallization on the other hand the suppression of the crystallization is achieve by adding slow crystallizing additives to the reaction mixture during esterification. Thus, the extent of crystallinity and size and shape of the crystallites can be controlled by the process of the present disclosure to a level sufficient to maintain the required thermal, mechanical and optical properties of the PET polyester. Thus, the process of the present invention helps to achieve the crystallinity up to 4%; crystals of spherules size up to 0.5 micron and I.V. up to 0.94 dl/g.

The crystallization rate and growth of crystallites can be controlled by slightly retarding the rate of crystallization. The slight retardation in the rate of crystallization helps limiting the shape and size of the crystallites and ensures transparency along with increase crystallinity.

Thus, the crystallized polyester of the present disclosure is suitable for rigid packaging or containers by application for transparent containers in both monolayer as well as multilayer containers.

In accordance with one aspect of the present invention, there is provided a heat resistance, preferably microwaveable, polyethylene terephthalate (PET) polyester composition that includes but is not limited to:
a. at least one dicarboxylic acid;
b. at least one diol;
c. at least one nucleating agent;
d. at least one or more crystallization suppressing agents;
e. at least one or more additives;
wherein the composition is characterized by at least one of the following properties:
   Intrinsic Viscosity>0.56 dL/g;
   Glass transition temperature (Tg)<60° C.; and
   Crystallization exothermic peak temperature (Tch)<60° C.

In accordance with one of other aspect of the invention, there is provided a process for the preparation of the polyethylene terephthalate (PET) composition comprising:
(a) esterification of dicarboxylic acid and diol under atmospheric pressure and temperature between 170° C. to 225° C. for 3 to 4 hours;
(b) melt polymerization using DMT or MEG (DMT route process) or PTA and MEG (PTA route process) in presence of one or more catalysts or combinations thereof to extrude copolyester having intrinsic viscosity about 0.50 dL/g;
(c) addition of at least one nucleating agent in the esterification or polymerization;
(d) preparing amorphous granules from extrude obtained in step (b);
(e) crystallization of said amorphous granules obtained in step (d) in rotary or fluid bed crystallizer at temperature of about 120° C. to about 150° C. for about 2 to about 6 hours to obtain surface crystallization granules;
(f) Solid state polymerization of the crystallized granules at temperature of about 150° C. and below melting temperature for about 4 to about 16 hours resulting in intrinsic viscosity (IV) about 0.95 dl/g or higher, and oligomer contents<105 meq/gm.

### DETAILED DESCRIPTION OF INVENTION

The present invention, provides modified polyethylene terephthalate polyester composition that can be used to produce transparent articles with improved thermal, optical, mechanical and rheological properties. In one aspect of the present invention, the modified polyethylene terephthalate can be processed to make transparent containers by extrusion and thermoforming and injection blow moulding techniques. The containers made from the modified polyethylene terephthalate (PET) have sufficient crystallinity so as to resist hot filling at up to 90° C. temperature. The containers comprising the modified PET can also be heated in microwave at temperature about 120° C. without shrinkage or shape deformation.

In accordance with one aspect of the present disclosure, there is provided a heat resistance, preferably microwaveable, polyethylene terephthalate (PET) polyester composition suitable for manufacturing heat resistant and/or microwaveable transparent containers that includes, but not limited to:
at least one dicarboxylic acid;
at least one diol;
at least one nucleating agent for initiating crystallization;
at least one crystallization suppressing agent for retarding the crystallization;
at least one or more additives.

Wherein, the polyester is characterized by at least one of the following properties:
Intrinsic Viscosity>0.50 dl/g;
Glass transition temperature (Tg)<60° C.; and
Crystallization exothermic peak temperature (Tch)<60° C.

Post-consumer recycled (PCR) PET flakes instead of PTA/DMT & MEG can be used as starting raw material. The recycling route can be mechanical extrusion or glycolysis with required filtration scheme.

Typically, the dicarboxylic acid is aliphatic and/ or aromatic acid and is at least one selected from the group that includes but is not limited to terephthalic acid, dimethyl terephthalate, isophthalic acid, dimethyl isophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-4,4′-methylenebis(benzoate), oxalic acid, dimethyl oxalate, malonic acid, dimethyl malonate, succinic acid, dimethyl succinate, methylsuccinic acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, dimethyl-1,4-cyclohexanedicarboxylate, 1,3-cyclohexanedicarboxylic acid, dimethyl-1,3-cyclohexanedicarboxylate, 1,1-cyclohexanediacetic acid, metal salts of 5-sulfo-dimethylisophalate, fumaric acid, maleic anhydride, maleic acid, hexahydrophthalic acid and phthalic acid. In one embodiment, 90-98 mol % of dicarboxylic acid is present.

The dicarboxylic acid of this embodiment preferably is purified terephthalic acid (PTA) or dimethyl terephthalate (DMT).

In another embodiment, 2-10 mol % of dicarboxylic acid is present. The dicarboxylic acid of some embodiment is selected from the group consisting of isophthalic acid (IPA), 2,6-napthalene dicarboxylic acid (NDA), adipic acid, sebacic acid succinic acid, azelic acid and/or combination thereof.

Typically, the diol is at least one selected from the group that includes but is not limited to mono ethylene glycol (MEG), diethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, dimer diol, 1,4-cyclohexanedimethanol, di(ethylene glycol), tri(ethylene glycol), poly(ethylene ether) glycols, poly(butylene ether) glycols, branched diols, isosorbide, (cis, trans) 1,3-cyclohexanedimethanol and (cis, trans) 1,4 cyclohexanedimethanol. Typically, the branched diol includes C4-C16 aliphatic branched diols and is at least one selected from the group that includes but is not limited to 2-methyl-1, 3-propanediol, 2, 2-dimethyl-1, 3-propanediol, 2-butyl-2-ethyl-1, 3-propanediol and trimethylpentanediol. In the embodiment where a cycloaliphatic diol moiety is included as a diol, it is supplemented with at least one additional cyclic or branched diol. In one embodiment 80-99 mol % of mono ethylene glycol (MEG) is used as the diol.

The liquid plasticizer of the present disclosure includes, but not limited to. N-isopropyl benzene sulfonamide, N-tert-butyl benzene sulfonamide, N-pentyl benzene sulfonamide, N-hexyl benzene sulfonamide, N-n-octyl benzene sulfonamide, N-methyl-N-butyl benzene sulfonamide, N-methyl-N-ethyl benzene sulfonamide, N-methyl-N-propyl benzene sulfonamide, N-ethyl-N-propyl benzene sulfonamide, N-ethyl p-ethylbenzene sulfonamide, N-ethyl p(t-butyl)benzene sulfonamide, N-butyl p-butyl benzene sulfonamide, N-butyl (mixed) toluene sulfonamide, N-t-octyl (mixed) toluene sulfonamide, N-ethyl-N-2-ethylhexyl (mixed) toluene sulfonamide and N-ethyl-N-t-octyl (mixed) toluene sulfonamide and tri octyl trimellitate. The aforementioned term ‘mixed’ may be defined as a mixture of the ortho and para isomers of toluene.

A nucleating agent is included in the composition of the present disclosure to improve its crystallinity and heat deformation temperature. The nucleating agent is inorganic and/ or organic nucleating agent and is present in an amount ranging between 5 ppm and 2000 ppm with respect to the total mass of the composition. The inorganic nucleating agent is at least one selected from the group that includes but is not limited to calcium silicate, nano silica powder, talc, Microtalc, Aclyn, kaolinite, montmorillonite, synthetic mica, calcium sulfide, boron nitride, barium sulfate, aluminum oxide, neodymium oxide and a metal salt of phenyl phosphate.

In some embodiments of the present invention, the inorganic nucleating agent is modified by an organic material to improve its dispersibility in the composition of the present invention.

The organic nucleating agent of the present invention is at least one selected from the group that includes but is not limited to carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluoylate, sodium salicylate, potassium salicylate, zinc salicylate, aluminum dibenzoate, potassium dibenzoate, lithium dibenzoate, sodium β-naphthalate and sodium cyclohexane carboxylate; organic sulfonates such as sodium p-toluene sulfonate and sodium sulfoisophthalate; carboxylic acid amides such as stearic acid amide, ethylene bislauric acid amide, palmitic acid amide, hydroxystearic acid amide, erucic acid amide and tris(t-butylamide) trimesate; phosphoric compound metal salts such as benzylidene sorbitol and derivatives thereof, and sodium-2,2′-methylenebis(4,6-di-t-butylphenyl)phosphate; and 2,2-methylbis(4,6-di-t-butylphenyl)sodium and polymers.

In one aspect of the present invention, the nucleating agent is a polymeric material. The polymeric material used in the present method is selected from the group that includes, but not limited to, end-capped oligomers, low I.V. Polymers of PET, PBT, PTT, PTN, PBN etc. In some embodiments of the present invention the polymeric materials can be added in chips form. In some of the embodiments the nucleating agent can be manufactured in-situ nucleating agents. In some embodiments portion of fast crystallizing agent, e.g. polybutylene terephthalate (PBT) can be replaced by alternative polymers, e.g. polyolefin. Thus the use of PBT can be reduced up to 5 wt. %. The polyolefin are used in an amount about 2 wt. % to 5 wt. %.

A suppressing agent is added during the process of the present invention, to retard the crystallization so that the growth and propagation of crystallites can be controlled as per requirement. The suppressing agent is selected from the group that includes but is not limited to dicarboxylic acids, diol, and slow crystallized polymers, e.g. polyesters, polyolefin, etc. In one embodiment the suppressing agents are used in an amount up to 20 wt. %.

In accordance to one embodiment, the dicarboxylic acids used as suppressing agents are selected from the group that includes but is not limited to isophthalic acid (IPA), dimethyl isophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-4,4′-methylenebis(benzoate), oxalic acid, dimethyl oxalate, malonic acid, dimethyl malonate, succinic acid, dimethyl succinate, methylsuccinic acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, dimethyl-1,4-cyclohexanedicarboxylate, 1,3-cyclohexanedicarboxylic acid, dimethyl-1,3-cyclohexanedicarboxylate, 1,1-cyclohexanediacetic acid, metal salts of 5-sulfo-dimethylisophalate, fumaric acid, maleic anhydride, maleic acid, hexahydrophthalic acid and phthalic acid. In one embodiment the diacid used as suppressing agent preferably is isophthalic acid (IPA).

In one of the embodiments, the diol used as suppressing agent is at least one selected from the group that includes but is not limited to mono ethylene glycol (MEG), diethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, dimer diol, 1,4-cyclohexanedimethanol, di(ethylene glycol), tri(ethylene glycol), poly(ethylene ether) glycols, poly(butylene ether) glycols, branched diols, isosorbide, (cis, trans) 1,3-cyclohexanedimethanol and (cis, trans) 1,4 cyclohexanedimethanol. Typically, the branched diol includes C4-C16 aliphatic branched diols and is at least one selected from the group that includes but is not limited to 2-methyl-1, 3-propanediol, 2, 2-dimethyl-1, 3-propanediol, 2-butyl-2-ethyl-1, 3-propanediol and trimethylpentanediol. In the embodiment where a cycloaliphatic diol moiety is included as a diol, it is supplemented with at least one additional cyclic or branched diol. In one embodiment the diol used as suppressing agent preferably is diethylene glycol (DEG) or propylene glycol (PEG).

The composition may also have other additives such as polycondensation catalysts and other additives. Catalysts that may be used include salts of Li, Ca, Mg, Mn, Zn, Pb, Sb, Sn, Ge, and Ti, such as acetate salts and oxides, including glycol adducts, and Ti alkoxides. These are generally known in the art, and the specific catalyst or combination or sequence of catalysts used may be readily selected by a skilled practitioner. The preferred catalyst and preferred conditions differ depending on, for example, whether the diacid monomer is polymerized as the free diacid or as a dimethyl ester and the exact chemical identity of the other diol component.

The other additives include but are not limited to pigments; flame retardant additives, particularly, decabromodiphenyl ether and triarylphosphates, such as triphenylphosphate; reinforcing agents, such as glass fibers; thermal stabilizers; ultraviolet light stabilizers processing aids, impact modifiers, flow enhancing additives. Other possible additives include polymeric additives including ionomers, liquid crystal polymers, fluoropolymers, olefins including cyclic olefins, polyamides, ethylene vinyl acetate copolymers and the like. With the help of melt phase polymerization polymer granules of I. V. of 0.73 dl/g to 0.95 dl/g can be manufactured on cooling the molten polymer under water and further cut it into chips. Thus, the amorphous polymer chips obtained from the above process are further upgraded in solid state polymerization (SSP) to achieve the required I.V. level. The co polymer produced in this manner have improved heat resistance, good color (L*>60%, a* of −2.2 & b* of >2.5) and good transparency, improved melt flow characteristic and can be used to manufacture articles by normal ISBM, IBM, IM, EBM processes (without heat set blow molding process) for applications in rigid packaging containers and films. The articles of the modified polyester can be manufactured by any process known in the art.

In case of 4/5 gallon water containers, the containers can be washed at elevated temperature above 60° C. (72 to 85 degree Celsius or even higher temperature if required).

In accordance with another aspect, there is provided a process for the preparation of modified polyethylene terephthalate composition. The process involves melt polymerization and subsequent solid state polymerization process. The melt polymerization process can be carried out either using DMT or MEG (DMT route process) or PTA and MEG (PTA route process) or using PCR PET flakes by employing glycolysis and repolymerization process to yield amorphous granules of I.V. range 0.73 dl/g to 0.95 dl/g. During the process catalyst and additives are incorporated at appropriate stages. Catalyst like antimony trioxide, antimony triacetate, Ti compounds, germanium dioxide, tin compounds, cobalt acetate etc. can be used as catalysts. Phosphorous compounds such as phosphoric acid may be used as stabilizers. Food grade di stuffs/tonors or cobalt acetate are used as a color moderators.

The amorphous polymer granules manufactured by melt phase polymerization are crystallized in any convention crystallizer and subsequently processed in batch or continuous solid state polymerization (SSP) to get the desired intrinsic viscosity (I.V.). The batch SSP may be pursed with nitrogen to expedite the reaction. In continuous SSP the circulating nitrogen gas is used as a carrier of byproducts.

The melt polymerization process is a process for making the polymer and is described in detail below. The melt polymerization processes may be based on DMT route or PTA route or PCR PET flakes based route.

The present disclosure can also be carried out by using batch process or continuous process in both melt polymerization and solid state polymerization.

### Melt Polymerization

The melt polymerization process can be carried out in either batch, semi-continuous or continuous mode. The process is best carried out in a reactor equipped with a distillation column and a stirrer or other means for agitation. The distillation column separates the volatile product of reaction (water and/or alkanol) from volatile reactants (e.g., ethylene glycol). Use of a distillation column allows for operation at a lower molar ratio of ethylene glycol to terephthalic acid, which serves to suppress the formation of diethylene glycol (DEG). Melt polycondensation can be carried out in conventional processes like PTA, DMT and PCR PET glycolysis. When terephthalic acid is used in the polymerization process, the volatile reaction product will be water; when an ester such as dimethyl terephthalate is used, the volatile reaction product will be the corresponding alkanol (such as methanol), together with smaller amounts of water.

### Solid State Polymerization

The copolyester can be made by the melt condensation process described above having an inherent viscosity of at least about 0.750 dl/g, and often as high as about 0.95 dl/g or greater, without further treatment. For microwaveable Co-PET articles, a copolyester having an inherent viscosity of at least about 0.750 dl/g, and preferably about 0.95 dl/g, is generally desirable to obtain articles having good thermal and optical properties. The product made by melt polymerization, after extruding, cooling, and pelletizing, is in amorphous state (crystallinity<10%). The material can be made semi-crystalline by heating it to a temperature in the range of about 120° C. to about 150° C. for an extended period of time (about 2 to about 6 hours). This induces crystallization so that the product can then be heated to a much higher temperature to raise the molecular weight.

The crystallized polymer is subjected to solid state polymerization by placing the pelletized or pulverized polymer into a tumble drier of an inert gas, usually nitrogen, or under a vacuum of 1 Torr, at an elevated temperature, above 150° C. but below the melting temperature, for a period of about 4 to about 16 hours. Solid state polymerization is preferably carried out at temperatures of about 190° C. to about 210° C. which results in an increase in inherent viscosity to about 0.95dL/g or higher.

The polyester can also be made just by melt polymerization process, in which the acid component is either terephthalic acid or dimethyl terephthalate, and, also includes the free acid or dimethyl ester of any other aromatic diacids that may be included in the polymer composition. The diacids or dimethyl esters are heated with the diols (ethylene glycol, butane diol (BDO), optional diols) in the presence of a catalyst to a high enough temperature that the monomers react to form esters and diesters, then oligomers, and finally polymers. The polymeric product at the end of the polymerization process is a molten polymer. The diol monomers (e.g., ethylene glycol) are volatile and distill from the reactor as the polymerization proceeds. Therefore, an excess of these diols generally is charged to the reactor to obtain the desired polymer, and the amounts are adjusted according to the characteristics of the polymerization vessel. Melt polymerization processes using hydroxyethyl esters of terephthalic acid, such as bis (2-hydroxyethyl) terephthalate, are also known and may be modified to make the polymers described herein.

In accordance with another aspect, the at least one nucleating agent is an inorganic, organic, or a polymeric material.

In accordance with yet another aspect, the at least one nucleating agent is present in an amount ranging between 5 ppm and 2000 ppm with respect to the total mass of the composition.

In accordance with one another aspect, the inorganic nucleating agent is at least one selected from the group consisting of calcium silicate, nano silica powder, talc, Microtalc, Aclyn, kaolinite, montmorillonite, synthetic mica, calcium sulfide, boron nitride, barium sulfate, aluminum oxide, neodymium oxide and a metal salt of phenyl phosphonate.

In accordance with another aspect, the organic nucleating agent is at least one selected from the group consisting of carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluoylate, sodium salicylate, potassium salicylate, zinc salicylate, aluminum dibenzoate, potassium dibenzoate, lithium dibenzoate, sodium β-naphthalate and sodium cyclohexane carboxylate, organic sulfonates such as sodium p-toluene sulfonate and sodium sulfoisophthalate, carboxylic acid amides such as stearic acid amide, ethylene bislauric acid amide, palmitic acid amide, hydroxystearic acid amide, erucic acid amide and tris(t-butylamide) trimesate, phosphoric compound metal salts such as benzylidene sorbitol and derivatives thereof, and sodium-2,2′-methylenebis(4,6-di-t-butylphenyl) phosphate; and 2,2-methylbis(4,6-di-t-butylphenyl) sodium and polymers.

In accordance with yet another aspect, the polymeric material is selected from the group of PET, PBT, PTT, PTN, PBN, end-cap oligomers, etc.

In accordance with one another aspect, the polymeric material used in chips form or can be manufactured in-situ during the esterification or polymerization reaction.

In accordance with another aspect, the polymeric material is in an amount up to 70 wt % based on the weight of the polyester composition.

In accordance with yet another aspect, the polymer granules are processed into containers by extrusion and thermoforming, or injection stretch blow moulding (ISBM) process to achieve sufficient crystallinity.

In one another aspect, the containers are transparent and can withstand high temperature during hot filling up to 95° C., and during heating in microwave up to 120° C.

The products manufactured from the crystallizable and microwaveable PET polyester of the present disclosure by normal ISBM/IBM/IM/EBM processes has improved heat resistance and can withstand elevated temperature above 60° C. without any deformation and with minimum shrinkage. The other advantages of the PET composition of the present disclosure are good processability at lower temperature, transparency and microwaveable. However, the articles manufactured by all above-stated processes have good impact strength. This is significant considering the fact that normally PET articles prepared by conventional processes and designs cannot withstand microwave temperature. The articles prepared by the method of the present disclosure are able to sustain during microwave heating without any deformation due to high concentration of spherical crystallites with size of less than 0.5 micro without affecting the transparency of the article. As small size and spherical shape of the crystallites leads to minimum reflection of the light thus articles remain transparent with good clarity.

The present disclosure provides a modified crystallizable polyester or copolyester for the manufacture of packaging articles by ISBM/IBM/EBM processes which has heat resistant properties including good mechanical and optical properties. The present disclosure provides a co polyester which has good color (L*>75 a* of −2.2 & b* of 5.5±2.5) and good clarity. The present disclosure provides a polyester which has good impact strength, transparency and glass transition temperature (T_{g})<60° C. The present disclosure provides a polyester which has improved rheological properties which further enables manufacture of transparent articles by ISBM/IBM/IM and EBM processes without need of heat set blow molding and these containers have improved heat resistance and they can be heated at elevated temperature more than 60° C. & these articles when heated in microwave oven do not display any abnormal shrinkage/deformation. When the articles are manufactured by heat set blow molding using by the method known in the art, the resultant modified copolyester demonstrates further improved heat resistance and can be heated at microwave temperature about 120° C. The present disclosure provides a process for the preparation of a polyester (also can be referred to as “copolyester”) composition which gives consistent properties. The manufacturing process can be based on DMT route, PTA route or by using PCR PET flakes in batch polymerization plant also in a continuous polymerization plant. The up gradation can be done either in a batch SSP plant or continuous SSP plant to achieve the required I.V. level. The present disclosure provides a copolyester for manufacturing transparent packaging containers well known molding process.

The present disclosure provides a copolyester resin composition suitable for making rigid package containers by injection molding and these containers will have good transparency, good color, good impact strength and improved heat resistance so that they can withstand high temperature above 60° C. The present disclosure provides a copolyester composition with improved melt flow properties and also improved flowability to enable manufacture of microwavable containers by injection molding process. The present disclosure provides a copolyester resin composition with enhanced thermal properties and optical properties.

The present disclosure is further described in light of the following examples which are set forth for illustration purpose only and not to be construed for limiting the scope of the disclosure.

### Quality Parameters

### Intrinsic Viscosity

Intrinsic viscosity (I.V.) is a measure of the molecular mass of the polymer and is measured by dilute solution using an Ubbelohde viscometer. All intrinsic viscosities are measured in a 60:40 mixture of phenol and s-tetrachloroethane with 0.5% concentration. The flow time of solvent and solution are checked under I.V. water bath maintained at temperature bout 25° C. The I.V., η, was obtained from the measurement of relative viscosity, ηr, for a single polymer concentration by using the Billmeyer equation:

IV=[η]=0.25[(RV−1)+3 ln RV]/c

Wherein η is the intrinsic viscosity, RV is the relative viscosity; and c is the concentration of the polymeric solution (in g/dL). The relative viscosity (RV) is obtained from the ratio between the flow times of the solution (t) and the flow time of the pure solvent mixture (t₀).

RV=nₙₑₜ=Flow time of solution (t)/Flow time of solvant (t₀)

I.V. must be controlled so that process ability and end properties of a polymer remain in the desired range. Class ‘A’ certified burette being used for IV measurement for more accuracy.

### Color

The color parameters were measured with a Hunter Lab Ultrascan VIS instrument. D65 illuminant and 10° angle is being used for color measurement. Both Amorphous and Solid State Polymerized (SSP) were used to check by reflectance mode of Hunter Color Scan. Generally, the changes measured could also be seen by eyes. The color of the transparent amorphous/SSP chips was categorized using the Hunter Scale (L/a/b) & CIE Scale (L*/a*/b*) values which are based on the Opponent-Color Theory. This theory assumes that the receptors in the human eyes perceive color as the following pairs of opposites.
L/L* scale: Light vs. Dark where a low number (0-50) indicates dark and a high number (51-100) indicates light.
a/a* scale: Red vs. Green where a positive number indicates red and a negative number indicates green.
b/b* scale: Yellow vs. Blue where a positive number indicates yellow and a negative number indicates blue.

The L* values after SSP are higher because of whitening caused by spherulitic crystallization of the polymer.

### DEG/EG/IPA/BDO Content

To determine the Diethylene Glycol (DEG), Ethylene Glycol (EG), Isophthalic Acid (IPA) and Butanediol (BDO) in sulfonated co-polyesters, Polymer sample is trans-esterified with methanol in an autoclave at 200° C. temperature for 2.5 hours with zinc acetate as a catalyst.

During methanolysis, the polymer sample is depolymerized and the liquid is filter through Whatman 42 filter paper. After filtration, 1 micro liter of the liquid was injected in Agilent Gas Chromatography (GC) under controlled GC configuration. Based on the RT (Retention Time), DEG/EG/IPA/BDO are calculated with Internal Standard ISTD (tetraethylene glycol dimethyl ether) and results are declared as wt. %.

### COOH End Groups

The Polymer was dissolved in a mixture of phenol and chloroform (50:50 w/v) under reflux conditions. After cooling to room temperature, the COOH end groups were determined using titration against 0.025 N Benzyl alcoholic KOH solution with bromophenol blue as an indicator. Run a blank simultaneously along with sample and the final end point is at the color change from blue from yellow. COOH groups are calculated based on the below calculation and the results are expressed in meq of COOH/kg. In the equation, TR is the volume of benzyl alcoholic KOH consumed for the sample, N is the normality of benzyl alcoholic KOH, and the blank is the volume of benzyl alcoholic KOH consumed for sample solution.

[(TR−Blank)×N×1000]=COOH end groups (meq/kg)

### DSC Analysis

The Differential Scanning Calorimeter (DSC) is a thermal analyzer which can accurately and quickly determine the thermal behavior of Polymers such as glass transition temperatures (Tg), crystallization exothermic peak temperatures (Tch), peak endotherm temperatures (Tm), heats of crystallization (ΔH) and heats of fusion for all materials. A Perkin-Elmer model Jade DSC was used to monitor thermal properties of all polymer samples at heating and cooling rates of 10° C. per minute. A nitrogen purge was utilized to prevent oxidation degradation.

### Crystallinity by DSC and DGC

The Differential Scanning Calorimeter (DSC) and Density Gradient Column (DGC) are used to calculate the crystallinity of polymer samples.

By DSC, the crystallinity is calculated by heat of fusion ((ΔH) of Tm1 (Heat 1 cycle) with specific heat of polymer. By DGC (Density Gradient Column), the crystallinity is calculated with the help of known standard balls floating at the Lloyds densitometer.

### Oligomer Content

The oligomer content in the polymer samples was determined by Soxhlet reflux methods. Polymer samples were reflux with 1, 4-dioxane for 2 hours in a mantle heater. After 2 hours, the refluxed sample is filtered through Whatmann 42 filter paper and the filtrate was transferred to a clean, dry, pre-weighed 100 ml glass beaker. The filtrate was then heated to dryness on a hot plate at 180° C. After drying, the beaker was kept in an air oven at 140° C. for 30 minutes. Finally, the oligomer content wt. %) was calculated according to the following:

{[(Beaker with Residue (g))−(Empty Beaker (g))]/sample weight (g)}×100.

The following examples are given for the purpose of illustrating various embodiments of the invention and are not meant to limit the present invention in any fashion. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

### Examples

The following examples are given for the purpose of illustrating various embodiments of the invention and are not meant to limit the present invention in any fashion. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

In one example, to a 20 L liter volume reactor equipped with a mechanical stirrer, a packed reflexing column, a nitrogen inlet and a heat source were added 2.6 kg of 1, 4 butane diol (BDO), 10.5 kg of polybutylene terephthalate (PBT) chips, 4.5 kg of isophthalic acid (IPA), 1.9 g of cobalt acetate (30 ppm as cobalt), 3 gm of nyacol dp5480 (200 ppm), 0.150 gm of micro talc. The esterification was carried out at temperature of 220-225° C. under pressure up to atmospheric pressure for 3-4 hours. The reaction byproduct, i.e., butanol was collected before addition of IPA. After completion of the esterification, the monomers, oligomers, were transferred into polycondensation reactor. Polycondensation reaction was carried out at temperature of 225-260° C. under pressure of 760 torr. After completion of the polymerization and sufficient melt viscosity is achieved, polymerization was stopped. The molten copolymer was cooled in the cold water and then chopped to form pellets. The intrinsic viscosity of the amorphous copolymer is 0.0.72 dl/g. The amorphous chips obtained from the above said process were further subjected to solid state polymerization to increase the I.V. up to 0.95 dl/g. The reaction conditions particularly, temperature, pressure and time mentioned in the above example are varying and may be decided the process conditions of the esterification and polymerization reaction.

In one example, initially 13.75kg of BDO were charged in a esterification reactor under atmospheric pressure and at temperature ranging from 170° C. to 220° C., then 56 kg of polybutylene terephthalate (PBT) chips and 30 PPM of cobalt acetate (CoAc) were added to the BDO solution, then the mixture were reacted under atmospheric pressure at temperature ranging from 170° C. to 225° C. with peak temperature 224° C. The molar ratio of the PBT and BDO is 1:0.60. Esterification reaction were conducted for next 2 to 3 hours and the reaction byproduct, i.e., butanediol (BDO), were removed before addition of IPA. After removing the IPA, 24.0 kg of polyethylene terephthalate (PET) chips, 200 PPM of micro talc and 0.150 gm of nyacol dp5480 were added to the esterification reactor and were reacted under atmospheric pressure and temperature about 225° C. to complete the esterification reaction. After the esterification reaction is complete, the monomer were transferred via a 20 micron filter into the polycondensation reactor. Thereafter, the polymerization reaction were conducted under vacuum and temperature ranging from 225° C. to 255° C. with a peak for245° C. for two hours. The molten polymer, after achieving the required I.V. up to 0.72 dl/g was extruded and cut into chips under water cutter to obtain amorphous chips of the polyester. The amorphous chips obtained from the above said process were further subjected to solid state polymerization to increase the I.V. up to 0.94 dl/g. The reaction conditions particularly, temperature, pressure and time mentioned in the above example are varying and may be decided by the person skilled in the art based on his knowledge of on the process conditions of esterification and polymerization.

In one working example, up to about 24 wt % of polyethylene terephthalate, up to 10 wt % of isophthalic acid (IPA), and up to 70 wt % of polybutylene terephthalate or polybutylene naphthalate were reacted in the reactor as per the methods disclosed in the present invention to obtain the crystallized heat resistant polyester. Wherein the wt % is calculated based on the total weight of the final polyester. The heat resistant polyester was further processed to obtain transparent containers through extrusion and thermoforming techniques.

In an example containers can be manufactured through injection stretch blow moulding (ISMB) process, the modified heat resistant polyethylene terephthalate obtained from the above methods is used to manufacture 38 g*130 mm long on 4 caring injection molding machine of 130 tonnage. Prior to that the resin was dried at 170° C. for 5 hours. The molding temperature was 280-285° C. The preforms were conditioned for 24 hours before starting blowing into bottles on blowing machine with single caring. The pre-forms were heated to 112° C. The blowing cycles time was 4.13 sec. Preblow pressure was 8 bar. Blow pressure was 30 bar. The bottles thus produced could be filled at 82±2° C. without any deformation.

In one another working example, the polyester obtained from the above examples was used on injection moulding machine to manufacture containers. Prior to that the chips were dried at 160° C. for 7 hours. The mold was cooled with chilled water of 6° C. The melt flow was satisfactory. The containers of 350μ wall thickness were manufactured. The containers were of good color & transparency and could be filled at 82° C. temperature.

In a preferred example the polyester chips obtained from the methods of the present invention are first converted into polyester sheets by extrusion process, then the sheet was heated to a pliable temperature using electric heaters. Once the sheets are heated, the soften sheet is placed on the mold and the desired shape is obtained by applying an external pressure. Finally finishing processes such as trimming, drilling, etc. are carried out when the shape is cooled and hardened. The finished container obtained can be used for various applications such as food packaging.

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. A polyethylene terephthalate (PET) composition suitable for manufacturing heat resistant and/or microwaveable containers comprising:
a. at least one dicarboxylic acid;
b. at least one diol;
c. at least one nucleating agent;
d. at least one or more crystallization suppressing agents;
e. at least one or more additives;
wherein the composition is characterized by at least one of the following properties:
Intrinsic Viscosity>0.56 dL/g;
Glass transition temperature (Tg)<60° C.; and
Crystallization exothermic peak temperature (Tch)<60° C.

2. The composition as claimed in claim 1, wherein the at least one dicarboxylic acid is aliphatic and/or aromatic acid.

3. The composition as claimed in claim 1, wherein the at least one dicarboxylic acid is selected from the group consisting of terephthalic acid, dimethyl terephthalate, isophthalic acid, dimethyl isophthalate, 2,6-napthalene dicarboxylic acid, dimethyl-2,6-naphthalate, 2,7-naphthalenedicarboxylic acid, dimethyl-2, 7-naphthalate, 3,4′-diphenyl ether dicarboxylic acid, dimethyl-4,4′-methylenebis(benzoate), oxalic acid, dimethyl oxalate, malonic acid, dimethyl malonate, succinic acid, dimethyl succinate, methylsuccinic acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, dimethyl-1,4-cyclohexanedicarboxylate, 1,3-cyclohexanedicarboxylic acid, dimethyl-1,3-cyclohexanedicarboxylate, 1,1-cyclohexanediacetic acid, metal salts of 5-sulfo-dimethylisophalate, fumaric acid, maleic anhydride, maleic acid, hexahydrophthalic acid and phthalic acid.

4. The composition as claimed in claim 1, wherein the at least one diol is selected from the group consisting of mono ethylene glycol, diethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, dimer diol, 1,4-cyclohexanedimethanol, di (ethylene glycol), tri (ethylene glycol), poly (ethylene ether) glycols, poly (butylene ether) glycols, branched diols, isosorbide, (cis, trans)1,3-cyclohexanedimethanol and (cis, trans) 1,4 cyclohexanedimethanol.

5. The composition as claimed in claim 4, wherein the branched diol includes C4-C16 aliphatic branched diols.

6. The composition as claimed in claim 5, wherein the branched diol is at least one selected from the group consisting of 2-methyl-1,3-propanediol, 2,2-dimethyl-1,3-propanediol, 2-butyl-2-ethyl-1,3-propanediol and trimethylpentanediol.

7. The composition as claimed in claim 1, wherein the at least one diol is a cycloaliphatic diol moiety.

8. The composition as claimed in claim 7, wherein the cycloaliphatic diol moiety is supplemented with at least one additional cyclic or branched diol.

9. The composition as claimed in claim 1, wherein the at least one nucleating agent is an inorganic or organic nucleating agent.

10. The composition as claimed in claim 1, wherein the at least one nucleating agent is a polymeric material.

11. The composition as claimed in claims 1, wherein the at least one nucleating agent is present in an amount ranging between 5 ppm and 2000 ppm with respect to the total mass of the composition.

12. The composition as claimed in claim 9, wherein the inorganic nucleating agent is at least one selected from the group consisting of calcium silicate, nano silica powder, talc, Microtalc, Aclyn, kaolinite, montmorillonite, synthetic mica, calcium sulfide, boron nitride, barium sulfate, aluminum oxide, neodymium oxide and a metal salt of phenyl phosphonate.

13. The composition as claimed in claim 9, wherein the organic nucleating agent is at least one selected from the group consisting of carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluoylate, sodium salicylate, potassium salicylate, zinc salicylate, aluminum dibenzoate, potassium dibenzoate, lithium dibenzoate, sodium β-naphthalate and sodium cyclohexane carboxylate, organic sulfonates such as sodium p-toluene sulfonate and sodium sulfoisophthalate, carboxylic acid amides such as stearic acid amide, ethylene bislauric acid amide, palmitic acid amide, hydroxystearic acid amide, erucic acid amide and tris(t-butylamide) trimesate, phosphoric compound metal salts such as benzylidene sorbitol and derivatives thereof, and sodium-2,2′-methylenebis(4,6-di-t-butylphenyl) phosphate; and 2,2-methylbis(4,6-di-t-butylphenyl) sodium and polymers.

14. The composition as claimed in claim 10, wherein the polymeric material is selected from the group of PET, PBT, PTT, PTN, PBN, end-cap oligomers, etc.

15. The composition as claimed in claim 14, wherein the polymeric material used in chips form or can be manufactured in-situ during the esterification or polymerization reaction.

16. The composition as claimed in claim 10, wherein the polymeric material is in an amount up to 70 wt % based on the weight of the polyester composition.

17. The composition as claimed in claim 1, wherein the crystallization suppressing agent is selected from the group consisting of dicarboxylic acids, diol, polyesters and polyolefin.

18. The composition as claimed in claim 1, wherein the crystallization suppressing agent is selected from the group consisting of isophthalaic acid, 2,6-napthalene dicarboxylic acid (NDA), dimethyl-2,6-naphthalate (NDC), or mono ethylene glycol.

19. The composition as claimed in claims 1, wherein the suppressing agent is in an amount up to 20 wt. %.

20. The composition as claimed in claim 17, wherein the dicarboxylic acid is selected from the group consisting of isophthalic acid (IPA), dimethyl isophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-4,4′-methylenebis(benzoate), oxalic acid, dimethyl oxalate, malonic acid, dimethyl malonate, succinic acid, dimethyl succinate, methylsuccinic acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, dimethyl-1,4-cyclohexanedicarboxylate, 1,3-cyclohexanedicarboxylic acid, dimethyl-1,3-cyclohexanedicarboxylate, 1,1-cyclohexanediacetic acid, metal salts of 5-sulfo-dimethylisophalate, fumaric acid, maleic anhydride, maleic acid, hexahydrophthalic acid and phthalic acid.

21. The composition as claimed in claims 1, wherein the suppressing agent is isopthalic acid (IPA).

22. The composition as claimed in claims 1, wherein the diol is selected from the group consisting of mono ethylene glycol (MEG), ethylene glycol (EG), 1,3-propanediol, 1,4-butanediol, 1,6-hexanediol, 1,8-octanediol, 1,10-decanediol, 1,12-dodecanediol, 1,14-tetradecanediol, 1,16-hexadecanediol, dimer diol, 1,4-cyclohexanedimethanol, di(ethylene glycol), tri(ethylene glycol), poly(ethylene ether) glycols, poly(butylene ether) glycols, branched diols, isosorbide, (cis, trans) 1,3-cyclohexanedimethanol and (cis, trans) 1,4 cyclohexanedimethanol.

23. The composition as claimed in claim 22, wherein the branched diol includes C4-C16 aliphatic branched diols and is at least one selected from the group consisting of 2-methyl-1,3-propanediol, 2,2-dimethyl-1,3-propanediol, 2-butyl-2-ethyl-1,3-propanediol and trimethylpentanediol.

24. The composition as claimed in claims 1, wherein the diol is diethylene glycol (DEG) or propylene glycol (PEG).

25. The composition as claimed in claim 1, wherein the at least one or more additives is selected from the group consisting of polycondensation catalyst, flame retardant additives, reinforcing agents, thermal stabilizers, ultraviolet light stabilizers, processing aids, impact modifiers, flow enhancing additives, polymeric additives liquid crystal polymers, fluoropolymers and olefins.

26. The composition as claimed in claim 25, wherein the catalysts include salts of Li, Ca, Mg, Mn, Zn, Pb, Sb, Co, Sn, Ge, P and Ti including glycol adducts and Ti alkoxides.

27. The composition as claimed in claim 25, wherein the flame retardant additive is decabromodiphenyl ether and triarylphosphates.

28. The composition as claimed in claim 25, wherein the reinforcing agents, is glass fibers.

29. The composition as claimed in claim 25, wherein the olefins is cyclic olefins, polyamides, ethylene vinyl acetate copolymers.

30. The composition as claimed in claim 25, wherein the catalyst is selected from the group consisting of antimony trioxide, Cobalt Acetate, Germanium Oxide, Phosphoric Acid, Titanium Oxide or combination thereof.

31. A process for the preparation of a heat resistant polyethylene terephthalate (PET) composition comprising:
(a) esterification of dicarboxylic acid and diol under atmospheric pressure and temperature between 170° C. to 225° C. for 3 to 4 hours;
(b) melt polymerization using DMT or MEG (DMT route process) or PTA and MEG (PTA route process) in presence of one or more catalysts or combinations thereof to extrude copolyester having intrinsic viscosity about 0.50 dL/g;
(c) addition of at least one nucleating agent in the esterification or polymerization;
(d) preparing amorphous granules from extrude obtained in step (b);
(e) crystallization of said amorphous granules obtained in step (d) in rotary or fluid bed crystallizer at temperature of about 120° C. to about 150° C. for about 2 to about 6 hours to obtain surface crystallization granules;
(f) Solid state polymerization of the crystallized granules at temperature of about 150° C. and below melting temperature for about 4 to about 16 hours resulting in intrinsic viscosity (IV) about 0.95 dl/g or higher, and oligomer contents<105 meq/gm.

32. The process as claimed in claim 31, wherein the at least one nucleating agent is an inorganic, organic, or a polymeric material.

33. The process as claimed in claims 31, wherein the at least one nucleating agent is present in an amount ranging between 5 ppm and 2000 ppm with respect to the total mass of the composition.

34. The process as claimed in claim 32, wherein the inorganic nucleating agent is at least one selected from the group consisting of calcium silicate, nano silica powder, talc, Microtalc, Aclyn, kaolinite, montmorillonite, synthetic mica, calcium sulfide, boron nitride, barium sulfate, aluminum oxide, neodymium oxide and a metal salt of phenyl phosphonate.

35. The process as claimed in claim 32, wherein the organic nucleating agent is at least one selected from the group consisting of carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluoylate, sodium salicylate, potassium salicylate, zinc salicylate, aluminum dibenzoate, potassium dibenzoate, lithium dibenzoate, sodium β-naphthalate and sodium cyclohexane carboxylate, organic sulfonates such as sodium p-toluene sulfonate and sodium sulfoisophthalate, carboxylic acid amides such as stearic acid amide, ethylene bislauric acid amide, palmitic acid amide, hydroxystearic acid amide, erucic acid amide and tris(t-butylamide) trimesate, phosphoric compound metal salts such as benzylidene sorbitol and derivatives thereof, and sodium-2,2′-methylenebis(4,6-di-t-butylphenyl) phosphate; and 2,2-methylbis(4,6-di-t-butylphenyl) sodium and polymers.

36. The process as claimed in claim 32, wherein the polymeric material is selected from the group of PET, PBT, PTT, PTN, PBN, end-cap oligomers, etc.

37. The process as claimed in claim 36, wherein the polymeric material used in chips form or can be manufactured in-situ during the esterification or polymerization reaction.

38. The process as claimed in claim 36, wherein the polymeric material is in an amount up to 70 wt % based on the weight of the polyester composition.

39. The process as claimed in claim 31, wherein the polymer granules are processed into containers by extrusion and thermoforming, or injection stretch blow moulding (ISBM) process to achieve sufficient crystallinity.

40. The process as claimed in claim 39, wherein the containers are transparent and can withstand high temperature during hot filling up to 95° C., and during heating in microwave up to 120° C.
